(19) United States
(12) Patent Application Publication
(10) Pub. No.: US 2005/0106380 A1
(43) Pub. Date: May 19, 2005

(54) Gas generating polymers

(75) Inventors: Peter N. Gray, Chicago, IL (US); Michael D. Lelah, Chicago, IL (US); Peter Kwong, Wheeling, IL (US)

Correspondence Address: SENNIGER POWERS LEAVITT AND ROEDEL, ONE METROPOLITAN SQUARE, 16TH FLOOR, ST LOUIS, MO, 63102, US

(73) Assignee: Bernard Technologies, Inc.

(21) Appl. No.: 10/712,216

(22) Filed: Nov. 13, 2003

(51) Int. Cl. B32B 5/16

(52) U.S. Cl. 428/323; 428/330

(57) ABSTRACT

Gas generating and releasing articles consisting essentially of a polymer and a gas generating solid dispersed therein are described. The article generates and releases a gas in response to moisture and in the absence of an acid, a polymer that degrades to produce an acid, a compound that generates an acid in response to humidity, a hygroscopic compound, and an oxidant. The article may also generate and release a gas in response to energy.

### FIELD OF THE INVENTION

The present invention relates to gas generating polymer or plastic articles, such as liners, covers, pads, inserts, foams, and bags, for preventing, retarding, controlling, delaying or killing microbiological contamination in foods, agricultural crops and botanicals.

### BACKGROUND OF THE INVENTION

Polymers and plastics are generally employed in agricultural product packaging to preserve desirable product qualities such as freshness, taste, flavor, color and odor by functioning as a barrier against the intrusion of one or more of oxygen, carbon dioxide, moisture, microbes and the like, or the escape of flavors, carbon dioxide, ethylene, and odors. Inside the barrier an isolated, dynamic environment is created that changes with storage time and storage conditions, such as temperature. Products that contain high water content, such as melons, grapes, berries, meat and dairy products, release trapped moisture that accumulates over time. Problematically the packaged products are invariably contaminated by a residual, inoculate, concentration of microbes or bioburden. The trapped high moisture atmosphere and availability of nutrients creates favorable conditions for rapid microbe growth and product spoilage.

Gas generating devices and compositions have been used during packaging, transportation and storage of foods, agricultural crops and botanicals for protection from spoilage due to microbiological contamination from molds, fungus, viruses and bacteria. With the ever-increasing globalization of the food and agricultural industries, more products are being shipped greater distances than in the past. The result is extended transportation and storage times with the concomitant need for more effective product preservation.

Sulfur dioxide gas has been found to be particularly well suited against mold and fungi and has been used extensively to control Botrytis cineria induced grey mold decay in packaged grapes, lychees, and other fresh produce.

WO 00/03930 by Corrigan describes a moisture-activated sulfur dioxide releasing film comprising sodium metabisulfite dispersed in a blend of at least one hydrophilic polymer and at least one hydrophobic polymer. In particular, gas release rate is described as being a function of the ratio of the hydrophilic polymer to the hydrophobic polymer wherein the ratio controls both the rate at which water penetrates the film thereby causing gas generation and the gas transmission rate through the film and into the environment. Corrigan discloses ethylene/vinyl acetate (“EVA”) as a preferred hydrophilic polymer and linear low density polyethylene (“LLDPE”) as a preferred hydrophobic polymer. Blends containing an EVA:LLDPE weight ratio range of 30:70 to 80:20, and 10% to 30% by weight of sodium metabisulfite are described.

WO 03/018431 by Sanderson et al. describes a moisture-activated sulfur dioxide gas releasing multi-layer device comprising a gas generating matrix containing 10% to 30% by weight of sodium metabisulfite dispersed in a plastisol comprising about 58% by weight polyvinyl chloride (“PVC”) polymer and about 40% by weight of a plasticizer. The matrix is extruded onto a moving carrier sheet to which a cover sheet is applied thereby encasing the matrix. One or both of the carrier and/or cover sheet is permeable to moisture and sulfur dioxide. The highly plasticized matrix is of insufficient strength and must be supported by the carrier and cover sheets.

WO 94/10233 by Steele describes single layer or multi-layer sulfur dioxide releasing films comprising a solid sulfur dioxide gas releasing compound, a polymer and at least one other compound to control the rate of sulfur dioxide release. This compound is selected from a hygroscopic compound, an acid, a polymer that degrades to produce an acid or a compound that generates an acid in response to humidity. Although suitable sulfur dioxide sources include sulfite salts such as sodium sulfite, sodium metabisulfite, calcium metabisulfite and organic agents, not all of these sources are influenced by acid concentration.

EP 1,197,441 A2 to Clemes describes a moisture activated sulfur dioxide releasing multi-layer generator containing two sources of sulfur dioxide gas. The generator is a multi-layer laminate composite comprising alternating layers of (1) Kraft paper coated on one side with a first substance that generates sulfur dioxide in the presence of moisture and (2) Kraft paper coated on one side with polyethylene (“PE”). Pockets containing a second powder substance that releases sulfur dioxide are formed between laminate layers (1) and (2). Sulfur dioxide sources can be sodium metabisulfate, an acidic mixture comprising sodium sulfite and fumaric acid, or an acidic mixture comprising sodium sulfite and potassium bitartrate.

U.S. Pat. No. 5,106,596 to Clemes describes a moisture activated sulfur dioxide releasing laminate comprising two gas permeable polymer sheets conjoined with a laminating substance containing a dispersed sulfur dioxide releasing substance such as sodium metabisulfate, an acidic mixture comprising sodium sulfite and fumaric acid, or an acidic mixture comprising sodium sulfite and potassium bitartrate.

U.S. Pat. No. 3,559,562 to Carlson describes a sulfur dioxide releasing coating comprising a binder with sulfur dioxide releasing particles dispersed therein. Suitable binders are disclosed as lacquers and resins such as ethyl cellulose, cellulose acetate, cellulose acetate butyrate and polyvinylidene halides. In a preferred embodiment the binder comprises a wax containing a viscosity-increasing agent such as a polyolefin, with a wax to polymer ratio range of about 2:1 to about 8:1 by weight. Sulfur dioxide sources can be sodium bisulfite, a mixture of sodium sulfite and fumaric acid, a mixture sodium sulfite and potassium bitartrate, or combinations thereof.

Agricultural product packaging polymers are generally categorized as either barrier polymers or structural polymers. Some resins, such as ethylene vinyl alcohol (EVOH) are excellent moisture and gas barriers but lack sufficient strength to enable packages to be prepared from them. Such polymers, known in the art as primary polymers, function only as a gas barrier. For this reason they are usually coated onto a substrate, or co-extruded or laminated with a second material that provides structural integrity. The resulting two-polymer composite is of relatively high cost and difficult to recycle because they contain more than one type of plastic.

Other polymers, known as secondary polymers, possess both barrier properties and structural integrity. Examples include polyolefins, polyvinyl chloride (“PVC”), nitrile, polyethylene terephthalate (Mylar® or “PET”), polyurethane, polystyrene, polytetrafluoroethylene (Teflon® or “PTFE”), silicone rubber, neoprene and polyvinylidene chloride (“PVDC”). Those polymers can be used to form a monolayer structure. Monolayer structures are advantageous because their manufacturing processes are simple and relatively inexpensive. Moreover, the monolayers can be formed from a single polymer thereby facilitating recycle and reuse.

While the gas generating compositions and devices known in the art are effective to some extent, there are deficiencies in at least some respects. For example, gas releasing component concentrations may be limited, processes for preparing multi-layer laminate composites may require both film forming and lamination steps, compositions containing disparate polymers require complex formulation steps and the products are not amenable to recycling, some compositions require the presence of an acid or hygroscopic compound for gas release to occur thereby adding complexity and cost, compositions containing pockets of undispersed gas generating solid are prone to leakage and resultant product contamination, and controlled low concentration gas release over a period of days may be difficult to achieve. There is a need for high load gas releasing composites comprising a single polymer or polymer family, and one or more gas releasing components capable of moisture activated gas generation and release in the absence of acids and oxidants.

### SUMMARY OF THE INVENTION

The present invention is directed to a gas generating and gas releasing monolayer article consisting essentially of between 30.0% and 99.9% by weight of a polymer and between 0.1% and 70.0% by weight of a gas generating solid dispersed in the polymer. The article is free of an acid, a polymer that degrades to produce an acid, a compound that generates an acid in response to humidity, a hygroscopic compound, and an oxidant. The gas generating solid consists essentially of one or more gas generating and releasing components with at least one component being capable of generating and releasing at least one gas upon exposure of the article to moisture.

The present invention is also directed to a gas generating and gas releasing monolayer article comprising between 30.0% and 99.9% by weight of a first polymer and between 0.1% and 70.0% by weight of a gas generating solid dispersed in the polymer. The article is free of an acid, a second polymer, a compound that generates an acid in response to humidity, a hygroscopic compound, and an oxidant. The gas generating solid consists essentially of one or more gas generating and releasing components with at least one component being capable of generating and releasing at least one gas upon exposure of the article to moisture.

The present invention is also directed to a gas generating and gas releasing article comprising between 30.0% and 99.9% by weight of a first polymer and between 0.1% and 70.0% by weight of a gas generating solid dispersed in the polymer. The article is free of an acid, a second polymer, a compound that generates an acid in response to humidity, a hygroscopic compound, and an oxidant. The gas generating solid consists essentially of one or more gas generating and releasing components with at least one component being capable of generating and releasing at least one gas upon exposure of the article to moisture.

### DESCRIPTION OF THE PREFERRED EMBODIMENTS

In accordance with the present invention, a moisture activated gas releasing article (“article”) has been made that comprises a polymer and a moisture activated solid component that is capable of generating and releasing a gas. The article provides antimicrobial protection of packaged agricultural products and is capable of sustained generation and release of a gas in the absence of acids, polymers that degrade to produce an acid, a compound that generates an acid in response to humidity, a hygroscopic compound or oxidants. The gas generally controls the growth of microorganisms thereby providing protection of agricultural products from those microorganisms during packaging transportation and storage.

In a first embodiment, the polymeric article of the invention is a sheet, pad, foam, insert, or woven or non-woven bag, envelope, cover, laminate, liner, container or structured packaging material comprising a polymer and a dispersed solid component capable of generating and as gas upon exposure to moisture. The polymer component consists of one polymer or can comprise two or more polymers which can be selected from a single polymer family. In one embodiment, the solid component is a sulfur dioxide precursor salt such as, for example, sodium sulfite, sodium metabisulfite, sodium bisulfite, potassium metabisulfite, potassium sulfite, potassium bisulfite, lithium metabisulfite, lithium sulfite and lithium bisulfite. In addition, a colorant or dye may be added for aesthetic, light selection or light reducing effects.

The articles of the invention can include one or more additional gas generating and releasing component in addition to the solid component.

In a second embodiment, the polymeric article of the first embodiment includes at least one solid component capable of generating and releasing at least one gas upon exposure to electromagnetic energy. Preferably, this component is an inorganic light activated composition (e.g. Microlite® powder) as described in copending U.S. patent application Ser. No. 09/488,927 and WO 00/69775, all of which are incorporated by reference. Gases that can be released from this component include chlorine dioxide, chlorine, sulfur dioxide, carbon dioxide, ozone, hydrogen peroxide and nitrous oxide. Such components are described in greater detail below. Alternatively in this embodiment, two or more gases can be generated and released by the electromagnetic energy catalyzed substrate to provide a mixed atmosphere containing, for example, sulfur dioxide and chlorine dioxide. In this second embodiment the gas is generated and released by two mechanisms thereby increasing the range of antimicrobial efficiency. For example, some microbial growth can occur prior to the point at which the atmospheric moisture content within the article reaches the threshold concentration required to initiate moisture activated release. By incorporating a light activated gas releasing substrate, an initial gas release can be achieved during packaging operations such that an antimicrobial atmosphere is present soon after packaging thereby inhibiting the onset of microbial growth. In this way a delay in antimicrobial gas release and concomitant primary microbial growth may be avoided. Alternatively, in this second embodiment an initial gas atmosphere containing at least two gases can be established in the article through energy activation thereby providing an initial broad-spectrum antimicrobial environment. Upon achievement of atmospheric humidity sufficient for moisture activated gas generation and release, additional gas will be provided.

In a third embodiment, the polymeric article of the first embodiment includes at least one additional solid component capable of generating and releasing at least one gas upon exposure to moisture. This component can be an inorganic moisture activated composition (e.g., Microsphere® powder) as described in copending U.S. patent application Ser. No. 09/138,219, WO 99/39574, and U.S. Pat. Nos. 5,965,264 and 6,277,408, or an organic moisture activated composition as described in U.S. Pat. Nos. 5,360,609, 5,631,300, 5,639,295, 5,650,446, 5,668,185, 5,695,814, 5,705,092, 5,707,739, 5,888,528, 5,914,120, 5,922,776, 5,980,826, and 6,046,243, all of which are incorporated by reference. Gases that can be generated and released from this component include chlorine dioxide, chlorine, sulfur dioxide, carbon dioxide, hydrogen peroxide and nitrous oxide. Such components are described in greater detail below. Alternatively in this embodiment, two or more gases can be generated and released by the moisture activated acid releasing substrate to provide a mixed atmosphere containing, for example, sulfur dioxide and chlorine dioxide.

In a fourth embodiment, the polymeric article of the first embodiment includes at least one solid component capable of generating and releasing at least one gas upon exposure to electromagnetic energy and at least one additional solid component capable of generating and releasing at least one gas upon exposure to moisture.

The polymeric articles of the present invention are fully functional as a single polymer gas releasing monolayer. The monolayer articles may be optionally combined with other films, substrates, fabrics and the like to produce multi-layer films with specific characteristics needed for a particular use. For example, the monolayer may be laminated or otherwise attached to a substantially gas impermeable co-layer or substrate to provide an article exhibiting unidirectional gas release. Alternatively, one or both of the monolayer surfaces may be laminated or otherwise attached to a semi-permeable co-layer to produce an article with controlled moisture transmission rate. In this manner delayed and/or controlled gas release may be achieved even in environments with temperatures and relative humidities as high as 50° C. and 100%, respectively. Still alternatively, one or both surfaces of the monolayer may be laminated or otherwise attached to one or more co-layers selected to reduce light transmission and/or filter wavelength ranges, such as ultraviolet light. In this way delayed and/or controlled gas release from energy activated gas releasing components may be achieved even in bright sunlight. Yet alternatively, one or both surfaces of the monolayer may be laminated or otherwise attached to one or more co-layers selected to provide desired structural mechanical properties such as toughness, flexibility, abrasion resistance, texture and the like. Each surface of the gas releasing monolayer may optionally be attached to different co-layers selected from moisture filtering, light filtering and structural films.

The inventive monolayer or multi-layer polymeric articles may be used in the form of a sheet that is placed under or over products, or as an insert between the product units. Also contemplated is lamination of the inventive articles directly to a food storage container such as a carton, box, crate, pallet or bin. Alternatively, the articles may be formed into a liner that serves to line the food storage container into which the products are placed and which is then folded over to complete surround the packaged contents in the container thereby forming a gas atmosphere surrounding the product. Yet alternatively, the articles may be formed into a pad onto which the packaged products are placed. Still alternatively, the products may be placed into a bag formed from the article and then sealed wherein a gas atmosphere envelopes the products. The liner or bag may optionally have perforations that permit moisture to escape or other gases to enter. Yet alternatively, the article may be formed into a gas releasing shrink wrap into which perishable products may be packaged. The liner or bag may optionally have a resealable opening to allow products to be added or removed. Similarly, the liner or bag may optionally have a resealable port to allow the contained atmosphere to be altered by, for example, removing gas to create a partial vacuum, allowing injection of one or more gases, or changing the relative humidity.

Polymer Component

Polymers are generally employed in product packaging to preserve the flavor, freshness, color and odor of the product by functioning as a barrier or partial barrier against the entry of one or more of oxygen, moisture, specific wavelengths of light, microbes and the like, or the escape of flavors, aromas, and essential oils. Inside the barrier an isolated, dynamic environment is created that changes with storage time and temperature. Products that contain high water content, such as grapes and berries release moisture that is trapped and accumulates over time. Problematically, prior to packaging, the products invariably are contaminated by a residual, inoculate, concentration of microbes. The isolated high moisture atmosphere creates favorable conditions for rapid microbe growth and product spoilage.

Products deteriorate over time. Deterioration is primarily a function of microbial growth and chemical activity within the product that results in its breakdown, for example spoilage and over-ripening. Microbial growth increases rapidly with temperature with maximum growth occurring between about 15° C. and about 60° C. Growth rate decreases at temperatures outside that range.

Microbial growth is also a function of relative humidity. Relative humidity of the isolated atmosphere within the package barrier is generally a function of the water content of the contained product. A threshold relative humidity (“RH”) of about 60% is required to support mold growth, about 80% RH is needed to support yeast growth, and about 85% RH is required to support bacterial growth. Packaged products that are incapable of releasing enough moisture to create a RH of at least 60% are termed “dry foods” and are generally microbiologically stable. In that case, a simple water-impermeable barrier is sufficient to preserve product quality. Products such as grapes, berries, cheese and meat release significant water vapor resulting in RH values that may exceed the 60% threshold. Those products are microbiologically unstable and a simple moisture barrier may be ineffective to maintain product quality. Products such as grains and flowers are of intermediate moisture content. For those products moisture release is generally low enough that the threshold RH value is typically not exceeded during storage times of less than about 120 days in normal warehouse storage conditions of, for example, 30° C. at 70% RH. In other cases, product quality may be adversely affected from chemical reaction induced over-ripening even in the absence of RH values above the threshold needed to support microbial growth.

Over-ripening is a result of a complex combination of temperature and humidity mediated enzymatic and oxidation reactions. Generally, fruits and vegetables should remain sufficiently hydrated and require oxygen to ripen. For those applications, polymeric packaging material is typically designed for oxygen permeability and water impermeability. In the case of high fat content products such as dairy and meat products, the fat can oxidize and become rancid. Those products should remain as free as possible from oxygen and a packaging material that acts as an oxygen barrier is preferred.

The polymer generally serves two functions. First, it forms a structural barrier within which a product is contained in an environment that may be essentially isolated or transient. Secondly, it serves as a platform for containment of solid gas releasing components within its structure. Both functions require some degree of permeability, whereby species such as gases, vapors or liquids may be exchanged or transmitted between the contained and external environments, with the rate of transmission generally being a function of a combination of the permeating species properties, the concentration gradient of those species between the environments, the properties of the polymer barrier and environmental conditions.

Generally, diffusion may be either active and/or passive. In passive diffusion the molecule simply passes through a porous polymer opening in response to a concentration gradient and does not interact with the polymer. The passive diffusion rate is a function of polymer molecular size. For example, oxygen diffuses at a faster rate through LDPE than through HDPE. Passive diffusion is also a function of pore size and concentration gradient, and high exchange rates can occur with large pore size. Diffusion rate is also a function of the size of the diffusing molecule. For instance, for a given polymer, the diffusion rate for the following molecules is listed in the order of highest to lowest: oxygen, water, methanol and ethanol. Passive diffusion can be affected by factors such as polymer crosslinking and polymer elongation through stretching, vacuum packing or shrink wrapping. Generally passive permeability decreases with increasing degrees of crosslinking and elongation.

In active diffusion a physical and/or chemical interaction between the molecule and the polymer occurs. Under one theory, and without being bound to any particular theory, active passage of molecules through a polymer article involves: (1) absorption of the molecule onto the polymer surface; (2) dissolution of the molecule into the polymer; (3) concentration gradient driven diffusion through the polymer to the opposite surface; and (4) desorption. Active diffusion is a strong function of the polymer functional groups. For example, polymers such as ethyl cellulose and polyvinyl alcohol having polar moieties such as hydroxyl groups interact with polar vapors such as water leading to high water absorption and permeability. Conversely, PVC, HDPE, LDPE, polystyrene and PTFE are relatively non-polar polymers with lower vapor transmission rates. In general, condensable vapors and liquids permeate at higher rates than gases. Some liquids and condensable vapors act as solvents which can swell and plasticize the polymer thereby actively increasing dissolution into the polymer and diffusion through the polymer. Polymers that are inert to gases, vapors and liquids are preferred.

The polymer component of the gas generating articles generally consists of a single polymer or two or more polymers from a single family of polymers. Suitable polymers include, for example, polyolefins (e.g., polyethylene, butene base, heptene base, octene and metalacene PE), PVC, nitrile, nylon (including nylon 6 and nylon 66), PET, polyurethane, polystyrene, PTFE, silicone rubber, neoprene and PVDC.

It is preferred that the polymer component has a melt temperature below the temperature at which significant gas source decomposition and subsequent gas release occurs. For example, in the case of sulfur dioxide releasing inorganic salts, the temperature is preferably less than about 150° C., and preferably between about 105° C. and about 150° C. It is further preferred that the polymer have a melt index of between about 0.5 to about 8.0 in order to enable ease of processing into finished articles such as a sheet, bag, pad, insert, foam, envelope, cover, container, laminate or liner by means known in the art such as film extrusion, thermoforming, injection molding, blow molding, rotational molding and sintering. In addition, the polymer should be capable of being processed even when loaded with as much as about 70% by weight of a gas generating solid.

The article forming process should be substantially non-aqueous because the articles of the invention release gas through water vapor mediated gas source oxidation. Thus aqueous based polymers such as, for example, latex and polyvinyl alcohol are generally not preferred. Moreover, the formed article should have low residual moisture. A residual moisture level of less than about 5.0% by weight is preferred, and more preferably less than 4.5%, 4.0%, 3.5%, 3.0%, 2.5% or 2.0% by weight.

The polymers of the present invention are suitable for preparation of articles generally capable of supporting a total solid gas releasing component loading of preferably at least about 0.1% by weight, and more preferably at least about 0.5%, 1.0%, 2.0%, 3.0%, 4.0%, 5.0%, 10%, 15%, 20%, 25%, 30%, 35%, 40%, 45%, 50%, 55%, 60%, 65% or 70% by weight. At those loadings, the polymers are capable of being processed into the inventive articles having a monolayer thickness preferably between about 5 μm and about 1000 μm, and more preferably between about 5 μm to 900 μm, 5 μm to 800 μm, 5 μm to 700 μm, 5 μm to 600 μm, 5 μm to 500 μm, 5 μm to 400 μm, 5 μm to 300 μm, or 5 μm to 200 μm.

Selection of a suitable polymer is generally dictated by the desired end use characteristics such as moisture permeability, light transmission and filtering capabilities, toughness, flexibility, abrasion resistance, texture, thickness, vacuum rating and the like.

PET polymer articles generally can be processed into gas releasing articles and exhibit high strength at film thicknesses from about 10 μm to 50 μm. Moreover, the articles are useful over a wide temperature range of about −40° C. to about 240° C. PET can be blow molded into gas releasing bottles, containers, crates, boxes, and the like. PET can also be formed into gas releasing sheets or films suitable for overwrapping or liners.

Suitable polyolefin polymers include PE, polypropylene (“PP”), butene base, heptene base, octene and metalacene PE. Polyolefins are of low cost and can be processed into gas releasing monolayer articles having high strength and desired permeability characteristics. Polyolefin monomers are also of low toxicity therefore the presence of some unreacted monomer in the formed polymer is relatively harmless. High density PE (“HDPE”) and low density PE (“LDPE”) are characterized by somewhat low oxygen and water permeability, low cost, toughness, flexibility and inertness. HDPE is generally characterized by temperature resistance and stiffness and can be easily formed into containers. LDPE generally can be stretched into fine, tough films and are typically used for grocery bags, bread bags and frozen food bags. PP films are generally more hard and transparent than PE films and are preferred for applications where transparency is desired. Cross-linked PE and PP films exhibit increased gas permeability. Non-gas releasing polyolefin films are extensively used for storing fresh fruits and vegetables, and are usually perforated to allow them to “breathe” and thereby provide high permeability.

Polystyrene films are characterized by low cost, rigidity, strength, clarity, low required thickness and resistance to water absorption. Because of their high strength, polystyrenes may be thermoformed into gas releasing packaging trays for fruits, vegetables, dairy products and meats. Moreover, polystyrene is suitable for shrink wrapping which is particularly suitable for packaging of marine food products.

Nylon films are useful for applications requiring thermoforming and crack and abrasion resistance. Nylon is particularly suitable for low temperature applications such as frozen food containers, yet a wide range of temperature resistance is exhibited making them useful as boiling bags. Nylon films are also extensively used in vacuum packaging operations which is particularly suitable for packaging of meat and fish.

Polyester provides formed articles that are tough, chemical resistant, clear and sterilizable. Polyester films are particularly suitable for vacuum, gas and shrink wrap packaging.

Polyurethane films are exceptionally tough, elastic and resistant to abrasion making them particularly suitable where elongation and puncture resistance is required. Urethane polymers are used where harsh packaging and transportation conditions are present and are used extensively as radiated food containers and for military applications.

PVC and PVDC films are characterized by almost complete impermeability of oxygen and water vapor as well as clarity, puncture resistance and “cling” which facilitates sealing. They can be used as a film of 0.5 to 4 mil thickness or be formed into a rigid container or blow molded into bottles, cartons, boxes and the like. PVC and PVDC are of relatively low cost.

PET films are generally impermeable to oxygen. They form hard, transparent monolayers and have been used extensively for liquid product storage such as liquor, oils, fruit juice and colas.

Gas Releasing Components

The gas-releasing component is typically one which generates and releases a gas upon exposure to humidity and/or electromagnetic energy.

In the gas releasing article embodiments of the invention, controlled sustained release of a gas can be generated from a composition containing a moisture activated gas-releasing component. In general, gas release occurs when the component is oxidized by water vapor. Gas release occurs in the absence of an added source of an acid, a substance that produces an acid in the presence of water, a hygroscopic compound and/or an oxidant such as iron sulfate or calcium sulfate. Sulfur dioxide is a preferred gas. Sources of sulfur dioxide include sodium bisulfite, potassium bisulfite, lithium bisulfite, calcium bisulfite, sodium metabisulfite, potassium metabisulfite, lithium metabisulfite, calcium metabisulfite, sodium sulfite and potassium sulfite. In general the sulfur dioxide source is dispersed as a solid in a polymer melt and then processed by methods known in the art to produce the gas generating article.

Generally, SO₂ sources having an average particle size of less than about 500 μm are preferred. However, the preferred particle size varies depending on the desired gas release profile characteristics. For example, in applications requiring a slow release rate, hence low atmospheric concentration sustained over an extended time period (e.g., more than about 120 days), a large particle size is desired because the surface area to weight ratio is minimized. Thus a particle size between about 50 μm and about 500 μm, between about 50 μm and about 400 μm, between about 50 μm and about 300 μm, between about 50 μm and about 200 μm, or between about 50 μm and about 100 μm is preferred. In applications requiring a faster release rate over an intermediate time period (e.g., up to about 120 days) a particle size between about 30 μm and about 300 μm, between about 30 μm and about 200 μm, between about 30 μm and about 100 μm, or between about 30 μm and about 75 μm is preferred. In applications requiring an even faster release rate, hence high atmospheric concentration sustained over a short time period (e.g., up to about 90 days) a high surface area to weight ratio is desired. A particle size between about 3 μm and about 200 μm, between about 3 μm and about 100 μm, between about 3 μm and about 75 μm, or between about 3 μm and about 50 μm is preferred.

In addition to particle size, other factors affect the SO₂ release rate and duration. For example, SO₂ source loading at the lower end of the preferred range of about 1% to about 50% by weight may give a profile characterized by a low atmospheric concentration over a short time duration. Conversely, high loading may give high atmospheric SO₂ concentrations for extended periods of time. SO₂ source gas release rate also varies with pH. Low pH favors rapid oxidation and therefore high gas release rates. Generally the gas release rate begins to increase at pH values less than about 5.0 and accelerates as the pH is further reduced. Article processing temperatures may also affect SO₂ gas release profiles. For example, SO₂ sources typically decompose rapidly at temperatures exceeding about 150° C. and evolve sulfur dioxide gas. Hence articles processed at temperatures exceeding the upper end of the preferred range of between about 105° C. and about 150° C. will exhibit diminished SO₂ gas release rates and duration as significant quantities may be lost during processing.

In the second and fourth gas releasing article embodiments, an additional solid component can be included which generates and releases a gas upon exposure to electromagnetic energy. Energy activated gas-generating components are described in U.S. patent application Ser. No. 09/448,927 and WO 00/69775, and are commercially available under the Microlite® trademark (Bernard Technologies). The solid component comprises an energy activated catalyst and anions. The anions are either oxidized by the activated catalyst or reacted with species generated during activation of the catalyst to generate the gas. The generation of gas can be suspended by stopping exposure of the component to electromagnetic energy, and resumed by again exposing the component to electromagnetic energy. The component can be repeatedly activated and deactivated in this manner as needed for a desired use. The component preferably includes a photoactive catalyst so that the anions are photo-oxidized. The component can also be composed entirely of inorganic materials so that it is odorless.

The energy-activated solid component preferably comprises between about 50 wt. % and about 99.99 wt. % of an energy-activated catalyst capable of being activated by electromagnetic energy, and between about 0.01 wt. % and about 50 wt. % of a source of anions capable of being oxidized by the activated catalyst or reacted with species generated during activation of the catalyst to generate a gas, and more preferably, between about 80 wt. % and about 98 wt. % of the energy-activated catalyst and between about 2 wt. % and about 20 wt. % of the anion source, and most preferably, between about 86 wt. % and about 96 wt. % of the energy-activated catalyst and between about 4 wt. % and about 14 wt. % of the anion source. When the component is exposed to electromagnetic energy, the energy-activated catalyst is activated and the anions are oxidized or reacted to generate and release the gas.

Without being bound by a particular theory of the invention, it is believed that the energy activated component generates a gas via one or more of the following mechanisms. When exposed to electromagnetic energy, the energy-activated catalyst absorbs a photon having energy in excess of the band gap. An electron is promoted from the valence band to the conduction band, producing a valence band hole. The valence band hole and electron diffuse to the surface of the energy-activated catalyst where each can chemically react. An anion is oxidized by the activated catalyst surface when an electron is transferred from the anion to a valence band hole, forming the gas. It is believed that sulfur dioxide, chlorine dioxide or nitrogen dioxide are generated by such transfer of an electron from a sulfite, chlorite or nitrite anion to a valance band hole. It is believed that these and other gases, such as ozone, chlorine, carbon dioxide, nitric oxide, nitrous oxide, hydrogen sulfide, hydrocyanic acid, and dichlorine monoxide, can also be formed via reaction of an anion with protic species generated during activation of the catalyst by abstraction of an electron from water, chemisorbed hydroxyl, or some other hydrated species. The gas diffuses out of the article into the surrounding atmosphere for a period of up to about six months to affect materials situated near the article. Articles that release several parts per million of gas per cubic centimeter per day for a period of at least one day, one week, one month or six months can be made by the processes of the present invention for a variety of end uses, including destruction or prevention of the growth of microorganisms such as bacteria, molds, fungi, algae, protozoa, and viruses on products, or inhibition or prevention of biochemical decomposition, respiration control, and control, delay. Although the articles generally provide controlled sustained release of a gas, the articles can be made so that gas is released during less than one day if desired for a particular end use.

Any source containing anions that are capable of being oxidized by the activated catalyst or reacted with species generated during excitation of the catalyst to generate a gas can be used in the energy activated component. An anion is capable of being oxidized by the activated catalyst to generate a gas if its oxidation potential is such that it will transfer an electron to a valence band hole of the energy-activated catalyst. Preferably, a solid contains the anions. Suitable solids include a salt of the anion and a counterion; an inert material such as a sulfate, a zeolite, or a clay impregnated with the anions; a polyelectrolyte such as polyethylene glycol, an ethylene oxide copolymer, or a surfactant; a solid electrolyte or ionomer such as nylon or Nafion™ (DuPont); or a solid solution. A powder can be formed, for example, by forming a solids-containing suspension in which a salt dissociates in a solvent to form a solution including anions and counterions, and the energy-activated catalyst is suspended in the solution and the suspension is then dried. Alternatively, the solid (e.g., salt particles) can be blended with the energy-activated catalyst particles.

Suitable salts for use as the anion source include an alkali metal bisulfite, an alkaline-earth metal bisulfite, a bisulfite salt of a transition metal ion, an alkali metal chlorite, an alkaline-earth metal chlorite, a chlorite salt of a transition metal ion, a protonated primary, secondary or tertiary amine, or a quaternary amine, a protonated primary, secondary or tertiary amine, or a quaternary amine, an alkali metal sulfite, an alkaline-earth metal sulfite, a sulfite salt of a transition metal ion, a protonated primary, secondary or tertiary amine, or a quaternary amine, an alkali metal sulfide, an alkaline-earth metal sulfide, a sulfide salt of a transition metal ion, a protonated primary, secondary or tertiary amine, or a quaternary amine, an alkali metal bicarbonate, an alkaline-earth metal bicarbonate, a bicarbonate salt of a transition metal ion, a protonated primary, secondary or tertiary amine, or a quaternary amine, an alkali metal carbonate, an alkaline-earth metal carbonate, a carbonate salt of a transition metal ion, a protonated primary, secondary or tertiary amine, or a quaternary amine, an alkali metal hydrosulfide, an alkaline-earth metal hydrosulfide, a hydrosulfide salt of a transition metal ion, a protonated primary, secondary or tertiary amine, or a quaternary amine, an alkali metal nitrite, an alkaline-earth metal nitrite, a nitrite salt of a transition metal ion, a protonated primary, secondary or tertiary amine, or a quaternary amine, an alkali metal hypochlorite, an alkaline-earth metal hypochlorite, a hypochlorite salt of a transition metal ion, a protonated primary, secondary or tertiary amine, or a quaternary amine, an alkali metal cyanide, an alkaline-earth metal cyanide, a cyanide salt of a transition metal ion, a protonated primary, secondary or tertiary amine, or a quaternary amine, an alkali metal peroxide, an alkaline-earth metal peroxide, or a peroxide salt of a transition metal ion, a protonated primary, secondary or tertiary amine, or a quaternary amine. Preferred salts include sodium, potassium, calcium, lithium or ammonium salts of a chlorite, bisulfite, sulfite, sulfide, hydrosulfide, bicarbonate, carbonate, hypochlorite, nitrite, cyanide or peroxide. Commercially available forms of chlorite and other salts suitable for use, can contain additional salts and additives such as tin compounds to catalyze conversion to a gas.

The gas released by the component will depend upon the anions that are oxidized or reacted. Any gas formed by the loss of an electron from an anion, by reaction of an anion with electromagnetic energy-generated protic species, by reduction of a cation in an oxidation/reduction reaction, or by reaction of an anion with a chemisorbed molecular oxygen, oxide or hydroxyl radical can be generated and released by the article. The gas is preferably sulfur dioxide, chlorine dioxide, carbon dioxide, nitrous oxide, dichlorine monoxide, chlorine or ozone.

Sulfur dioxide is generated and released if the component contains bisulfite or sulfite anions. Bisulfite sources that can be incorporated into the component include alkali metal bisulfites such as sodium bisulfite, potassium bisulfite or lithium bisulfite, alkaline-earth metal bisulfites such as calcium bisulfite, or bisulfite salts of a transition metal ion, a protonated primary, secondary or tertiary amine, or a quaternary amine. Such bisulfite salts dissociate in solution to form bisulfite anions and possibly sulfite anions. Sulfur dioxide gas-releasing articles can be used for food preservation (e.g. to inhibit biochemical decomposition such as browning of produce), disinfection, and inhibition of enzyme-catalyzed reactions. The components are also useful in modified atmosphere packaging by placing the article within a package, exposing the article to electromagnetic energy to generate sulfur dioxide, and sealing the package to create a sulfur dioxide atmosphere within the package.

Chlorine dioxide gas is generated and released if the component contains a source of chlorite anions. Suitable chlorite sources that can be incorporated into the component include alkali metal chlorites such as sodium chlorite or potassium chlorite, alkaline-earth metal chlorites such as calcium chlorite, or chlorite salts of a transition metal ion, a protonated primary, secondary or tertiary amine, or a quaternary amine such as ammonium chlorite, trialkylammonium chlorite, and quaternary ammonium chlorite. Suitable chlorite sources, such as sodium chlorite, are stable at processing temperatures in excess of about 90° C. when incorporated in the articles of the present invention, allowing for processing at relatively high temperatures. Chlorine dioxide-releasing articles can be used to deodorize, enhance freshness, retard, prevent, inhibit, or control chemotaxis, retard, prevent, inhibit, or control biochemical decomposition, retard, prevent or control biological contamination, or to kill, retard, control or prevent the growth of bacteria, molds, fungi, algae, protozoa, and viruses.

Chlorine gas and dichlorine monoxide are generated and released from a component containing hypochlorite anions. Acceptable sources of hypochlorite anions include alkali metal hypochlorites such as sodium hypochlorite, alkaline-earth metal hypochlorites such as calcium hypochlorite, or hypochlorite salts of a transition metal ion, a protonated primary, secondary or tertiary amine, or a quaternary amine. Chlorine gas-releasing articles can be used in processing meat, fish and produce. Dichlorine monoxide releasing articles can be used as a biocide.

Carbon dioxide gas is generated and released if a component contains a source of bicarbonate or carbonate anions. Suitable bicarbonate sources that can be incorporated into the component include alkali metal bicarbonates such as sodium bicarbonate, potassium bicarbonate, or lithium bicarbonate, alkaline-earth metal bicarbonates, or bicarbonate salts of a transition metal ion, a protonated primary, secondary or tertiary amine, or a quaternary amine such as ammonium bicarbonate. Such bicarbonate salts may dissociate in solution to form bicarbonate anions and possibly carbonate anions. The carbon dioxide-releasing articles can also be used in modified atmosphere packaging by placing the article within a package, exposing the article to electromagnetic energy to generate carbon dioxide, and sealing the package to create a carbon dioxide atmosphere within the package. The package can then be used to control respiration of produce, cut flowers or other plants during storage and transportation, or to retard, prevent, inhibit or control biochemical decomposition of foods.

A nitrogen oxide such as nitrogen dioxide or nitric oxide is generated and released from a component if it contains a source of nitrite anions. Suitable sources of nitrite anions include alkali metal nitrites such as sodium nitrite or potassium nitrite, alkaline-earth metal nitrites such as calcium nitrite, or nitrite salts of a transition metal ion, a protonated primary, secondary or tertiary amine, or a quaternary amine. Nitrogen dioxide or nitric oxide gas-releasing powders can be used to improve compatibility between products when more than one product is packaged in the same container, and for modified atmosphere packaging.

Ozone gas or hydrogen peroxide is generated and released if the component contains a source of peroxide anions. Suitable ozone sources that can be incorporated into the composition include alkali metal peroxides such as sodium peroxide or potassium peroxide, alkaline-earth metal chlorites such as calcium peroxide, or peroxide salts of a transition metal ion, a protonated primary, secondary or tertiary amine, or a quaternary amine. Ozone- or hydrogen peroxide-releasing articles can be used to deodorize, enhance freshness, retard, prevent, inhibit, or control chemotaxis, retard, prevent, inhibit or control biochemical decomposition, or to kill, retard, control or prevent the growth of bacteria, molds, fungi, algae, protozoa, and viruses.

In some instances, components contain two or more different anions to release two or more different gases at different rates. The gases are released for different purposes, or so that one gas will enhance the effect of the other gas. For example, an article containing bisulfite and chlorite anions may release sulfur dioxide for food preservation and chlorine dioxide for deodorization, freshness enhancement, control of chemotaxis, or control of microorganisms.

Any electromagnetic energy source capable of activating an energy-activated catalyst of the invention can be used to generate a gas from the component. In other words, any electromagnetic energy source that provides a photon having energy in excess of the band gap of the energy-activated catalyst is suitable. Preferred electromagnetic energy sources include light, such as sunlight, fluorescent light, and ultraviolet light, for photo-activation of the component. Ultraviolet light and visible light other than incandescent light, such as blue light, are preferred sources of electromagnetic energy. Additives such as UV blockers can also be included in the component if it is desirable to limit the wavelength range transmitted to the energy-activated catalyst. Photosensitizers can be added to shift the absorption wavelength of the composition, particularly to shift an ultraviolet absorption wavelength to a visible absorption wavelength to improve activation by room lighting. UV absorbers can be added to the component to slow the gas generation and release rate.

Any semiconductor activated by electromagnetic energy, or a particle or other material incorporating such a semiconductor, can be used as the energy-activated catalyst of the component. Such semiconductors are generally metallic, ceramic, inorganic, or polymeric materials prepared by various processes known in the art, such as sintering. The semiconductors can also be surface treated or encapsulated with materials such as silica or alumina to improve durability, dispersibility or other characteristics of the semiconductor. Catalysts for use in the component are commercially available in a wide range of particle sizes from nanoparticles to granules. Representative energy-activated catalysts include metal oxides such as anatase, rutile or amorphous titanium dioxide (TiO₂), zinc oxide (ZnO), tungsten trioxide (WO₃), ruthenium dioxide (RuO₂), iridium dioxide (IrO₂), tin dioxide (SnO₂), strontium titanate (SrTiO₃), barium titanate (BaTiO₃), tantalum oxide (Ta₂O₅), calcium titanate (CaTiO₃), iron (III) oxide (Fe₂O₃), molybdenum trioxide (MoO₃), niobium pentoxide (NbO₅), indium trioxide (In₂O₃), cadmium oxide (CdO), hafnium oxide (HfO₂), zirconium oxide (ZrO₂), manganese dioxide (MnO₂), copper oxide (Cu₂O), vanadium pentoxide (V₂O₅), chromium trioxide (CrO₃), yttrium trioxide (YO₃), silver oxide (Ag₂O), or TiₓZr₁₋ₓO₂ wherein x is between 0 and 1; metal sulfides such as cadmium sulfide (CdS), zinc sulfide (ZnS), indium sulfide (In₂S₃), copper sulfide (Cu₂S), tungsten disulfide (WS₂), bismuth trisulfide (BiS₃), or zinc cadmium disulfide (ZnCdS₂); metal chalcogenites such as zinc selenide (ZnSe), cadmium selenide (CdSe), indium selenide (In₂Se₃), tungsten selenide (WSe₃), or cadmium telluride (CdTe); metal phosphides such as indium phosphide (InP); metal arsenides such as gallium arsenide (GaAs); nonmetallic semiconductors such as silicon (Si), silicon carbide (SiC), diamond, germanium (Ge), germanium dioxide (GeO₂) and germanium telluride (GeTe); photoactive homopolyanions such as W₁₀O₃₂⁻⁴; photoactive heteropolyions such as XM₁₂O₄₀⁻ⁿ or X₂M₁₈O₆₂⁻⁷ wherein x is Bi, Si, Ge, P or As, M is Mo or W, and n is an integer from 1 to 12; and polymeric semiconductors such as polyacetylene. Transition metal oxides such as titanium dioxide and zinc oxide are preferred because they are chemically stable, non-toxic, inexpensive, exhibit high photocatalytic activity, and are available as nanoparticles useful in preparing transparent formed or extruded plastic products.

In the third and fourth gas releasing article embodiments, a gas such as sulfur dioxide or chlorine dioxide can be generated from an additional organic moisture-activated component. Organic moisture activated components are described in U.S. Pat. Nos. 5,360,609, 5,631,300, 5,639,295, 5,650,446, 5,668,185, 5,695,814, 5,705,092, 5,707,739, 5,888,528, 5,914,120, 5,922,776, 5,980,826, and 6,046,243.

Organic moisture activated gas-releasing components generally comprise a hydrophilic material, a hydrophobic material and anions that form a gas when the component is exposed to moisture. The component may be, for example, a dispersion composed of hydrophilic and hydrophobic phases, or a mechanical combination of the hydrophilic and hydrophobic materials, such as powders and adjacent films. The powder can have a hydrophobic core embedded with hydrophilic particles containing anions such as chlorite containing particles. Adjacent films comprise separate layers of the hydrophilic or hydrophobic materials.

Preferably, the organic gas-releasing component comprises between about 5.0 wt. % and about 95 wt. % hydrophilic material and between about 5.0 wt. % and about 95 wt. % hydrophobic material, more preferably between about 15 wt. % and about 95 wt. % hydrophilic material and between about 15 wt. % and about 95 wt. % hydrophobic material. If the component is a dispersion, either material can form the continuous phase. The continuous phase constitutes between about 15 wt. % and about 95 wt. % of the dispersion and the dispersed phase constitutes between about 5 wt. % and about 85 wt. % of the dispersion, and preferably, the continuous phase constitutes between about 50 wt. % and about 95 wt. % of the dispersion and the dispersed phase constitutes between about 5 wt. % and about 50 wt. % of the dispersion.

The hydrophobic material of the gas-releasing component can be composed entirely of an acid releasing agent or can comprise the acid releasing agent in combination with a diluent, dispersant and/or a plasticizer. Any acid releasing agent that is capable of being hydrolyzed by ambient moisture is acceptable for purposes of the present invention. The hydrophobic material comprises between about 10 wt. % and about 100 wt. % of the acid releasing agent, up to about 80 wt. % diluent, up to about 20 wt. % dispersant, and up to about 60 wt. % plasticizer, and preferably, between about 40 wt. % and about 100 wt. % of the acid releasing agent, between about 20 wt. % and about 80 wt. % diluent, between about 1 wt. % and about 10 wt. % dispersant, and up to about 20 wt. % plasticizer.

Suitable acid releasing agents include carboxylic acids, esters, anhydrides, acyl halides, phosphoric acid, phosphate esters, trialkylsilyl phosphate esters, dialkyl phosphates, sulfonic acid, sulfonic acid esters, sulfonic acid chlorides, phosphosilicates, phosphosilicic anhydrides, carboxylates of poly α-hydroxy alcohols such as sorbitan monostearate or sorbitol monostearate, phosphosiloxanes, and an acid releasing wax, such as propylene glycol monostearate acid releasing wax. Inorganic acid releasing agents, such as polyphosphates, are also preferred acid releasing agents because they form odorless powders generally having greater gas release efficiency as compared to powders containing an organic acid releasing agent. Suitable inorganic acid releasing agents include tetraalkyl ammonium polyphosphates, monobasic potassium phosphate, potassium polymetaphosphate, sodium metaphosphates, borophosphates, aluminophosphates, silicophosphates, sodium polyphosphates such as sodium tripolyphosphate, potassium tripolyphosphate, sodium-potassium phosphate, and salts containing hydrolyzable metal cations such as zinc. Preferably, the acid releasing agent does not react with the hydrophilic material, and does not exude or extract into the environment.

The hydrophobic material can include a diluent such as microcrystalline wax, paraffin wax, synthetic wax such as chlorinated wax or polyethylene wax, or a polymer such as atactic polypropylene, polyolefin, or polyester, or polymer blends, multicomponent polymers such as copolymers or terpolymers, or polymer alloys thereof.

The dispersant in the hydrophobic material is any substance that controls release of the gas from the component, lowers the surface reactivity of the hydrophilic material, and does not react with the hydrophilic material. Substances having hydrophilic and hydrophobic portions are preferred. The hydrophilic portion of the substance can be absorbed by the surface of the hydrophilic material. Preferred dispersants that can be incorporated into the hydrophobic material have a melting point not greater than 150° C., and include amides of carboxylates such as amide isostearates, polyvinyl acetates, polyvinyl alcohols, polyvinylpyrrolidone copolymers, and metal carboxylates such as zinc isostearate.

Plasticizers can also be incorporated in either the hydrophobic or hydrophilic materials as is known in the art. Generally, formamide, isopropylacrylamide-acrylamide, N-methylacetamide, succinamide, -ethylacetamide, N-methylformamide, N-ethylformamide, and amido substituted alkylene oxides are acceptable plasticizers.

The hydrophilic material of the organic gas-releasing component can be composed entirely of a source of anions which react with hydronium ions to form the gas or can comprise the anion source in combination with another hydrophilic material. The hydrophilic material preferably contains an amine, an amide or an alcohol, or a compound containing amino, amido or hydroxyl moieties and having a high hydrogen bonding density. A source of anions is incorporated in the hydrophilic material and preferably constitutes between about 2 wt. % and about 40 wt. % of the hydrophilic material in the form of anions and counterions, and more preferably, between about 8 wt. % and about 10 wt. % of the hydrophilic material. The anions generally do not react with the hydrophilic material, but are surrounded by hydrogen bonds contributed by the nitrogen or hydroxide within the hydrophilic material.

Preferred amides for use as the hydrophilic material include formamide, acrylamide-isopropylacrylamide, copolymers of formamide and acrylamide-isopropylacrylamide, and copolymers of acrylamide, isopropylacrylamide or N,N-methylene bisacrylamide and a primary amine or a secondary amine. Such amides can be useful vehicles for film casting prior to exposure to chlorine dioxide, which does not react with polymerizable, electron deficient alkenes such as acrylamide.

Suitable amines for use as the hydrophilic material include primary amines, secondary amines, and tertiary amines having pendant hydrogen bonding groups. An amine substituted with electron donating groups which donate electrons to convert chlorine dioxide to chlorite is preferred. Electron withdrawing groups concentrate electron density at such groups such that it is difficult for the chlorine dioxide to extract an electron from the amine. Tertiary amines having non-hydrogen bonding pendant groups which are dissolved in a hydrophilic solvent are also acceptable.

Preferred amines include monoethanolamine, diethanolamine, triethanolamine, a copolymer of 1,3-diaminopropane or 1,2-diaminoethane and N,N-methylene bisacrylamide, 4-dimethylaminopyridine, tetramethylene ethylene diamine, N,N-dimethylamino cyclohexane, solubilized 1-(N-dipropylamino)-2-carboxyamido ethane or 1-(N-dimethylamino)-2-carboxyamido ethane, a primary amine having the formula R₁NH₂, a secondary amine having the formula R₂R₃NH, N—(CH₂CH₂—OH)₃, 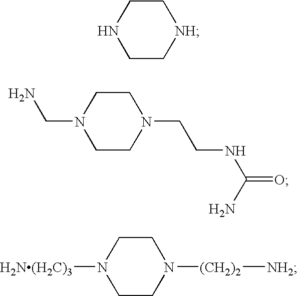
solubilized NR₅R₆R₇, (CH₃)₂NCH₂CH₂N(CH₃)₂, R₈R₉NCH₂CH₂C(O)NH₂, R₁₀N(NCH₂CH₂C(O)NH₂)₂, R₁₁R₁₂N(CH₂)₃NHC(O)NH₂, N(CH₂CH₂NHC(O)NH₂)₃, 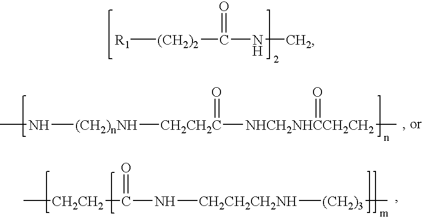
wherein: R₁ is —CH₂CH₂OCH₂CH₂OH, —C(CH₃)₂CH₂OH, —CH₂CH₂NHCH₂CH₂OH, —CH(CH₃)₂, —CH₂CH₂OH, 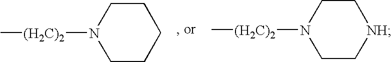
, or; R₂ and R₃ are, independently, hexyl, benzyl, n-propyl, isopropyl, cyclohexyl, acrylamide, or —CH₂CH₂OH; R₄ is cyclohexyl or benzyl; R₅ and R₆ are methyl; R₇ is cyclohexyl or 4-pyridyl; R₈ and R₉ are, independently, methyl, n-propyl or isopropyl; R₁₀ is n-C₆H₁₃ or n-C₁₂H₂₅; R₁₁ and R₁₂ are, independently, methyl, ethyl, n-propyl or isopropyl; m is an integer from 1 to 100; and n is 2 or 3. Suitable diluents include formamide or acrylamide-isopropyl acrylamide. Oligomeric or polymeric secondary amines converted to acrylamide substituted tertiary amines by Michael reaction with acrylamides are also suitable because the amide group does not react with the acid releasing agent.

Hydroxylic compounds, including ethylene glycol, glycerin, methanol, ethanol, methoxyethanol, ethoxyethanol or other alcohols, can be used as the hydrophilic material. However, chlorine dioxide release can occur very rapidly when a hydroxylic compound is incorporated in the composite and can limit the applications for such composites to rapid chlorine dioxide releasing systems.

The hydrophobic and hydrophilic materials are substantially free of water to avoid significant release of chlorine dioxide prior to use of the article. For purposes of the present invention, a hydrophilic material, a hydrophobic material, or a dispersion thereof is substantially free of water if the amount of water in the composite does not provide a pathway for transmission of hydronium ions from the hydrophobic material to the hydrophilic material. Generally, each of the hydrophilic and hydrophobic materials can include up to about 0.1 wt. % water without providing such a pathway for interdiffusion between the materials. Preferably, each material contains less than about 1.0×10⁻³ wt. % water, and, more preferably, between about 1×10⁻² wt. % and about 1×10⁻³ wt. % water. Insubstantial amounts of water can hydrolyze a portion of the acid releasing agent to produce acid and hydronium ions within the component. The hydronium ions, however, do not diffuse into the hydrophilic material until enough free water is present for transport of hydronium ions.

When the anion source is a salt, the salt dissociates in the hydrophilic material such that the hydrophilic material in the component will include anions and counterions. Suitable salts include those listed above for use in the energy-activated components.

The gas released by the component will depend upon the anions within the hydrophilic material. Any gas that is formed by reaction of a hydronium ion and an anion can be generated and released by the composite. The gas is preferably selected from those listed above for the energy-activated components.

The moisture activated organic components can be formulated in various ways to accommodate a wide range of end use applications. The component can be formulated as an extrudate, such as a sheet (including films), or pellets, or as a powder using conventional extrusion and spray drying methods, respectively. The component may be, for example, a dispersion composed of hydrophilic and hydrophobic phases, or a mechanical combination of the hydrophilic and hydrophobic materials, such as adjacent films. Adjacent films comprise separate layers of the hydrophilic or hydrophobic materials. The components can also be formulated in solvents to allow for film casting or other application methods. The component can be applied as a film by using well known hot melt, dip coat, spray coat, curtain coat, dry wax, wet wax, and lamination processes. Methods of making such components are known in the art as in U.S. Pat. No. 5,705,092.

In yet another embodiment, a gas such as sulfur dioxide or chlorine dioxide can be generated from an inorganic moisture-activated component. Inorganic moisture activated components (e.g., Microsphere® powder (Bernard Technologies)) are described in copending U.S. patent application Ser. No. 09/138,219 and U.S. Pat. Nos. 5,965,264 and 6,277,408.

A problem recognized in the art is decomposition of sulfite as SO₂ release in sulfite-containing particles at temperatures above about 150° C. and chlorite in chlorite-containing particles to chlorate and chlorite when exposed to temperatures above about 160° C. These temperature limitations have obviated desired high temperature processing applications such as melt processing or sintering in which the sulfite or chlorite is incorporated, for example, into extruded sheets (including films), or coatings.

For such high temperature applications the gas-releasing component may be formulated as a powder as described in copending U.S. patent application Ser. No. 09/138,219 and U.S. Pat. No. 6,277,408, and sold under the Microsphere® trademark.

The powder comprises a particle having an acid releasing layer on an outer surface of the particle. The particle is comprised of anions dissolved within an amorphous, paracrystalline or crystalline solid solution. The anions are capable of reacting with hydronium ions to generate a gas. The particle contains one or more phases, which may be amorphous, paracrystalline or crystalline, with the anions dissolved in one or more of the phases. In these phases, the dissolved anions are either randomly distributed (e.g., a solid solution), or distributed in an ordered crystalline lattice in which the anions are substantially prevented from being neighbors. Hence, the anions can be an interstitial component of an alloy or other crystalline solid solution, or can be dissolved in a glass or other amorphous or paracrystalline solid solution. In any case, the solute anions are dispersed at the ionic level within the solvent. Such co-dissolution of anions and a material capable of forming an amorphous, paracrystalline or crystalline solid solution with the anions, elevates the disproportionation temperature above that of the anionic compound alone.

A paracrystalline solid solution is generally a material having one or more phases that exhibit some characteristics of a crystalline state as demonstrated, for example, by broadening of the reflections in the x-ray diffraction pattern. The amorphous, paracrystalline or crystalline material is not a zeolite or other material which must be heated at a temperature that would destroy the anions in order to dissolve the anions in the material. Preferably, the particle is comprised of a substantially amorphous silicate. For purposes of the present invention, the term “substantially amorphous” is defined as including no more than 20% crystalline inclusions, preferably no more than 10%, and more preferably no more than 2%.

The silicate particle is preferably in the form of a substantially amorphous silicate matrix in which the anions are uniformly dispersed and encapsulated. The silicate particles generally range in size between about 0.1 and about 1,000 microns depending upon the intended end use, and can be made of any size possible via any solid forming process, but preferably via spray drying. The silicate particles are either solid or hollow, and are generally substantially spherical. The particle may include an inert core which can be any porous or nonporous particle that is insoluble in water or an aqueous solution of a water miscible organic material, such as a clay, ceramic, metal, polymer or zeolite material.

In the case of a solid solution formed from sulfite or chlorite anions and soluble silicate, it is believed that the sulfite or chlorite anions are separated within the silicate matrix thus inhibiting sulfite or chlorite anion intermolecular interaction resulting in elevated sulfite and chlorite disproportion temperature on the order of about 220° C. Preferably, each silicate particle comprises between about 3 wt. % and about 95 wt. % silicate, between about 1 wt. % and about 30 wt. % anions capable of reacting to generate a gas, and up to about 95 wt. % inert core. More preferably, the silicate particle comprises between about 4 wt. % and about 95 wt. % silicate, between about 1 wt. % and about 15 wt. % anions capable of reacting to generate a gas, and up to about 95 wt. % of an inert core.

The silicate particle is substantially free of water to minimize diffusion of the anions into solution when further processing the particle, such as when the particles are added to an aqueous slurry containing an acid releasing agent to form a powder for sustained release of a gas. The silicate particle is substantially free of water if the amount of water in the silicate particle does not provide a pathway for transmission of anions from the particle into a solvent. Preferably, each of the silicate particles includes up to about 10 wt. %, preferably up to about 5 wt. % water without providing such a pathway for diffusion from the particle to the solvent.

Any silicate that is soluble in water or a water solution of a water miscible organic material, such as an alcohol, acetone or dimethylformamide, can be used in the silicate particles. Suitable silicates include sodium silicate, sodium metasilicate, sodium sesquisilicate, sodium orthosilicate, borosilicates, and aluminosilicates.

The anions contained in the silicate particles which react with hydronium ions to form a gas and the acid releasing agents are as described above for the energy-activated components.

The silicate particles optionally contain a base or a filler. The base controls release of gas from the particle by reacting with hydronium ions that diffuse into the particle from an acid releasing layer or interdiffuse into the anion-rich areas of the particle to form a salt. When the base is depleted, excess hydronium ions then react with the anions within the particle to form a gas. The filler controls release of a gas by creating a barrier to diffusion of hydronium ions. The silicate particle preferably includes a base or filler if sulfite or chlorite anions are present in the particle to stabilize the sulfite or chlorite during preparation of the particle or a powder containing the particle. Any base that reacts with a hydronium ion or any filler can be incorporated in the silicate particle.

Alternatively, the powder can be formulated as a single phase or as an interpenetrating network. A powder is comprised of a plurality of the particles containing an interpenetrating network. The interpenetrating network contains an amorphous, paracrystalline or crystalline solid solution, anions that are capable of reacting with hydronium ions to generate a gas, and an acid releasing agent. The solid solution of the interpenetrating network is preferably a substantially amorphous material. A substantially water-insoluble silicate preferably surrounds the interpenetrating network to minimize diffusion of the anions into the solution used to prepare the powder so as to minimize loss of anions needed to generate a gas. Alternatively, the solid solution of the interpenetrating network can contain a water-soluble silicate. For purposes of the present invention, an “interpenetrating network” is a material comprised of two or more phases in which at least one phase is topologically continuous from one free surface to another. The particles are either solid or hollow, and are generally substantially spherical. The powders preferably are about 0.1 microns to about 1 millimeter in size.

In another embodiment, the powder is prepared from particles comprised of a single phase amorphous, paracrystalline or crystalline solid solution. Preferably, the solid solution contains a water-soluble silicate, anions that are capable of reacting with hydronium ions to generate a gas, and an acid releasing agent. The powder can also include particles containing an anhydrous material which contact an outer surface of the particle or are embedded in the particle. The anhydrous material is capable of binding with water. The powder is substantially free of water to avoid release of gas prior to use of the powder.

Another inorganic moisture-activated component is a powder containing a molecular sieve core encased within an acid releasing agent as described above for the energy-activated components. The core contains anions such as those described above for the energy-activated components. The core of each particle is generally a molecular sieve particle containing anions. Any molecular sieve can be used in the powders of the invention including natural and synthetic molecular sieves. Suitable molecular sieves include natural and synthetic zeolites such as clinoptiloite, analcite, analcime, chabazite, heulandite, natrolite, phillipsite, stilbite, thomosonite and mordenite, crystalline aluminophosphates, ferricyanides and heteropolyacids. Molecular sieves generally have a pore size ranging from about 5 to 10 Angstroms, and a particle size ranging from about 10 micrometers to about one centimeter.

Other Additives

One or more plasticizers known in the art may be added to the gas releasing article polymer melt to reduce T_{g} and/or alter rheological properties such as viscosity and flow characteristics so as to allow reduced temperature processing. Moreover plasticizers may function to reduce formed article embrittlement and therefore impart flexibility and prevent cracking. Polymer to plasticizer weight percent ratios of about 1:400, 1:200, 1:100, 1:50, 1:25, 1:10, 1:5 or 1:2 may be used. Acceptable plasticizers include, for example, N′,N′-ethylenebisstearamide and palmatide, N,N′-1,2-ethanediylbisoctadecanamide and hexadecanamide, N,N′-distearoylethylenediamine, N,N′-dipalmitoylethylenediamine fatty acid, bis(2-ethylhexyl)phthalate (DOP), 2,2,4-trimethyl-1,3-pentanediol diisobutyrate (TXIB), diisononylphthalate (DINP). formamide, isopropylacrylamide-acrylamide, -methylacetamide, succinamide, -ethylacetamide, N-methylformamide, -ethylformamide, polyalcohols (e.g., ethylene, polyethylene, propylene, polypropylene, butylene, polybutylene, neopentyl, methoxypolyethylene and poly(ethylene-propylene)glycols, butanediol, pentanediol, hexanediol, cyclohexanedimethanol, glycerin, trimethylolpropane, hexanetriol, and pentaerythritol and/or amido substituted alkylene oxides.

Film forming additives known in the art can be added to the hydrophobic and hydrophilic materials as needed. Such additives include crosslinking agents, flame retardants and compatibilizers. Suitable crosslinking agents include, for example, organic peroxides such as benzoyl peroxide and methyl ethyl ketone peroxide. Suitable flame retardants include, for example, carbon black, metal oxides, chlorine antimony, boron and phosphorus.

Lubricants known in the art may be added to the polymer melt to reduce friction between forming equipment and the polymer article. Lubricants also aid in emulsifying other components and inhibit the polymer from sticking to surfaces during processing. Lubricants include, for example, vegetable oils and microcrystalline waxes including silicone waxes. Surfactants, or emulsifiers, known in the art may be added to the polymer melt to facilitate gas releasing particle wetting and dispersion. Examples of surfactants include epoxidized soybean oil or Disperplast® 1150 (a polar acidic ester of a long chain alcohol available from BYK-Chemie of Wesel, Germany). Many lubricants also possess surfactant properties.

Pigments or colorants may be added to the articles of the invention. Pigments or colors may be incorporated generally homogeneously in the whole article, or selectively incorporated into one or more sections of the article. Any colorant, or dye, known in the art that provides the desired color, for example blue, yellow, red, green, etc., may be used. Pigments are preferred because they generally are more chemically inert, and thermal and light stable than are colorants. In the case of sulfur dioxide and/or chlorine dioxide, the color of some pigments is not affected by its generation and release and significant color change will not occur. Advantageously, some pigments known in the art can be oxidized by sulfur dioxide and/or chlorine dioxide with a resultant color change, for example from blue to green, and can be used to indicate the activity of the gas releasing article during and after use. Examples of suitable pigments include carbon, iron oxide, cobalt oxide, cadmium sulfide and lead sulfate.

Stabilizers known in the art may be added to impart high curing temperatures, prevent degradation during processing and use, and inhibit discoloration. The prepared article polymer possesses individual polymer molecules with a defined weight range and distribution, degree of cross-linking and gas releasing component loading. During use the finished article is exposed to released gas, stress, heat, light, oxygen, water and radiation, each of which or any combination of, may initiate degradation reactions. The net result is a change in polymer chemical composition and molecular weight. For example, in some cases chain scission results in a decrease in the molecular weight of the polymer, while in other cases the molecular weight may increase due to recombination reactions. Stabilizers may be incorporated into the polymer to inhibit degradation reactions. Stabilizers may be generically classed as antioxidants, antiozonants and UV absorbers. Stabilizer may be present in a concentration between about 0.05% and 2.5% by weight.

Antioxidants are generally added to inhibit atmospheric oxidative polymer degradation during processing and usage. Polymer oxidative degradation can lead to change in appearance such as discoloration and loss of mechanical properties such as strength and flexibility. Oxidation is particularly problematic in PP, PE and polystyrene polymers. Examples of suitable antioxidants include phenols, arylamines, phosphites, lactones, hydroxylamines, sulfur compounds, calcium stearate and zinc stearate.

Antiozonants known in the art may be added to prevent polymer degradation due to atmospheric ozone or released ozone. PE, PP, polystyrene, polyester, PVC and polyurethane polymers are susceptible to ozone-mediated degradation. Acceptable antiozonants include aromatic diamines such as p-phenylene diamine derivatives. Ultraviolet absorbers may be added to inhibit UV-mediated degradation, especially in PE, PP, polystyrene and polyester polymers. Examples of preferred UV absorbers include 2-hydroxygbenzophenones, 2-hydroxyphenylbenzotriazoles, 2-cyanodiphenyl acrylates and carbon black.

Preparation of Gas Generating Articles

The gas generating articles may be prepared by a variety of processes. For example, one or more gas releasing components may be incorporated directly into articles as a powder. Alternatively, one or more gas releasing components may be incorporated at a relatively high loading to form a polymer masterbatch additive that may then be subsequently blended with additional polymer and processed into articles. In one embodiment, a sulfur dioxide gas releasing component may be mixed with additional gas generating systems, such as sulfur dioxide, chlorine dioxide or carbon dioxide generators, to yield an article with enhanced release rate, increased release duration, and/or alter the gas generation and release kinetics.

The methods used to form the articles include melt extrusion for forming films, containers, trays, structured packaging material and the like. Melt extrusion methods include extrusion molding, injection molding, compression molding and blow molding. In extrusion molding, polymer pellets are fed through a heating element to raise the temperature above T_{g}, and the resulting plasticized polymer is then forced through a die to create an object of desired shape and size. Extrusion molding is generally done to produce thick films, trays, tubing, fittings and the like. Optionally however, a gas can be blown into the extruder to form polymer bags, thin films and multi-layer films from the plasticized polymer. Injection molding involves heating polymer powder or pellets above T_{g}, and in some cases above Tₘ, pressurized transfer to a mold, and cooling the formed polymer in the mold to a temperature below T_{g}. In compression molding, solid polymer is placed in a mold section, the mold chamber is sealed with the other section, pressure and heat are applied, and the softened polymer flows to fill the mold. The formed polymer object is then cooled and removed from the mold. Injection molding and compression molding are generally used to produce, for example, structured packaging material, trays, boxes, crates and fittings. Blow molding entails extrusion of a plasticized polymer into a mold and then inflating the polymer with air pressure against the sides of the mold thereby forming the article shape such as a bottle, jug, carboy, bin, container, etc. In yet another method a thin layer of polymer is spread evenly, or cast, over a surface such as a box or carton to form a gas-releasing coating.

Gas releasing films prepared by any method may be converted to any number or types of configurations including but not limited to sheets, bags, pads, inserts, foam, envelopes, covers, laminates and liners.

Sheets may be vacuum molded or thermoformed and die cut into a desired shape, for example, trays or structured packaging material for holding agricultural products. Sheets may also be employed as a gas releasing barrier layer where certain types of gas or moisture protection characteristics are required.

Flexible films can also be prepared and used to wrap or overwrap products. A shrink wrap can be used encase an agricultural product or to hold together a series of product containers. Stretch wrap can hold a number of large product items or a number of product containers together, or fasten them to a shipping container or pallet.

The selection of the appropriate polymer in many cases depends on the ultimate use. For example, PVC is generally used to prepare sheets and films by extrusion or injection. PET may be used to form containers, bottles and vacuum forming sheets. PET imparts excellent clarity and mechanical strength. PE and PP may be formed into sheets and films by extrusion and injection molding. Those polymers provide excellent surface characteristics, moldability, clarity, chemical resistance, weatherability and impact strength.

In a first embodiment for preparing a gas releasing article, one or more solid gas releasing components may be incorporated directly into articles as a powder at a total loading between about 0.1% and about 70% by weight. In this embodiment, one or more gas releasing components and a polymer resin are added directly into a melt extruder. One or more other components such as plasticizers, film forming additives, lubricants, pigments, colorants and stabilizers may also be added to the extruder. A gas releasing component is then formed by melt extrusion methods known in the art. In some embodiments such as bags, sheets, liners, bottles, containers, structured packaging material and the like, the formed single polymer gas releasing component can itself be a gas releasing article. In other embodiments one or both surfaces of the formed single polymer gas releasing component can be laminated or otherwise conjoined with other materials such as fabrics, packaging material, non-gas releasing polymer sheets, and other gas releasing articles to form a multi-layered article.

In a second embodiment for preparing a gas releasing article, one or more solid gas releasing components are combined with a polymer resin to form a masterbatch containing a total solid loading between about 10% and about 70% by weight. In this embodiment, one or more gas releasing components and a polymer resin are added directly into a melt extruder and thereafter formed into pellets or flakes for further processing into finished articles. One or more other components such as plasticizers, film forming additives, lubricants, pigments, colorants and stabilizers may also be added to the extruder.

The article can comprise one or more solid gas releasing components as described above including gas releasing salts, energy activated gas-generating and releasing components as described in U.S. patent application Ser. No. 09/448,927 and WO 00/69775, organic moisture activated components as described in U.S. Pat. Nos. 5,360,609, 5,631,300, 5,639,295, 5,650,446, 5,668,185, 5,695,814, 5,705,092, 5,707,739, 5,888,528, 5,914,120, 5,922,776, 5,980,826, and 6,046,243, and inorganic moisture activated components as described in copending U.S. patent application Ser. No. 09/138,219 and U.S. Pat. Nos. 5,965,264 and 6,277,408.

The energy activated component, organic moisture activated component, and/or inorganic moisture activated component can be incorporated directly into the melt extruder with one or more gas releasing salts, a polymer resin, and other optional components as described above to form a melt which is then formed directly into gas generating and releasing articles. In this embodiment a total solid loading of between about 0.1% and about 50.0% by weight is preferred. A masterbatch polymer melt can be similarly formed, but where a total solid loading of about 10% to about 70% by weight is preferred. The masterbatch melt is thereafter formed into pellets, particles or flakes for further processing.

If energy activated compositions are used in the production line, which includes material staging areas, mixing tanks, storage tanks, forming stations, etc., as well as the packaging lines, that equipment should be protected from strong light in order to inhibit premature gas release which may compromise finished product integrity. Generally this may be accomplished by using covered processing vessels, shielding the manufacturing and packaging areas from sunlight and artificial light and/or the use of low lighting or indirect lighting.

Definitions

As used herein, the term “article” is used in its broadest sense and is intended to cover sheets, bags, pads, inserts, foam, envelopers, covers, containers, laminates or liners prepared by conventional film extrusion, thermoforming, injection molding, blow molding, rotational molding and sintering methods known in the art.

As used herein, the term “microorganism” is used in its broadest sense and it intended to cover microorganisms such as molds, fungus, viruses and bacteria.

As used herein, the term agricultural product (“product”) is used in its broadest sense and is intended to cover all forms of agricultural and food products including but not limited to: fresh fruits such as grapes, strawberries, blueberries, raspberries, apricots, peaches, plums, lychees, pears and the like; vegetables such as mushrooms, beans, squash and the like; live plants; seeds; fresh cut flowers; marine food products such as shrimp, crabs, oysters, clams and fish.

As used herein, the term “polymer” is used in its broadest sense and is intended to cover a polymer family (e.g., polyolefins, polyesters or nylons). The phrase “a polymer” is therefore intended to cover one or more species within a polymer family such as, for example: polypropylene and/or polyethylene (polyolefins); PET and/or polyethylene naphthalate; or nylon 6 and/or nylon 66.

As used herein, the term “monolayer” is used in its broadest sense and intended to cover single layer articles having structural integrity such that it does not require a substrate (e.g., carrier sheet) for structural support during manufacture or use.

For purposes of this invention, the glass transition temperature (T_{g}) is defined as the lowest temperature at which a polymer can be considered softened and flowable. The polymer is a hard and glassy material at temperatures less than T_{g}. Glass transition is a characteristic of amorphous polymers. Due to a polymer's inherent amorphous content (nominally 40-70%), it undergoes a transition from a hard and brittle plastic to a soft rubbery material as it is heated. In contrast, if a thermoplastic polymer were 100% crystalline upon heating it would melt at a specific temperature rather than passing through a transition range. (Tₘ) is the temperature at which the structure of a crystalline polymer is destroyed to yield a liquid.

### WORKING EXAMPLES

Single polymer sulfur dioxide films containing sodium metabisulfite were prepared and evaluated for SO₂ release.

The films were evaluated for SO₂ emission under the following protocol. The analytical method utilized 11-liter boxes similar to table grape cartons used for export under controlled laboratory conditions. The films were evaluated in two forms: (1) as open plastic liners in the grape box and (2) as a single plastic sheet. Samples were placed in the box and the humidity was maintained over 95%. The temperature for the study was ambient at 20° C. The method is an accelerated procedure where 1 hour at evaluation conditions approximates 0.6 to 0.9 day of exposure under commercial storage and transport conditions.

### Example 1

Three Masterbatches were prepared by adding low density polyethylene (LDPE) and sodium metabisulfite (“NaMB”) directly into a polymer extruder at LDPE:NaMB weight ratios of 70:30, 60:40 and 50:50. The Masterbatch was extruded as pellets containing 30%, 40% and 50% by weight, respectively, of sodium metabisulfite using a twin screw vacuum vented extruder with all zones and die maintained below 150° C. and above 110° C.

### Example 2

Three films were prepared from the 40% Masterbatch as follows:

A first monolayer film containing 16% by weight of sodium metabisulfite was prepared using a single screw extruder with all zones and die kept below 150° C. and above 110° C. by adding (1) Masterbatch containing a 40% sodium metabisulfite loading and (2) LDPE to the polymer extruder at a Masterbatch to LDPE weight percent ratio of 2:3. A 875 cm² extruded film weighing 15.23 grams and having a thickness of about 50 μm to about 110 μm was prepared using processes and equipment normally used in cast film production. The film contained about 2.44 grams of sodium metabisulfite.

A second monolayer film containing 20% by weight of sodium metabisulfite was prepared using processes and equipment normally used in blown film production by adding (1) Masterbatch containing a 40% sodium metabisulfite loading and (2) LDPE to the polymer extruder at a Masterbatch to LDPE weight percent ratio of 1:1. A 3000 cm² extruded film weighing about 8.36 grams and having a thickness of about 50 μm to about 90 μm was prepared. The film contained about 1.67 grams of sodium metabisulfite.

A third monolayer film containing 37% by weight of sodium metabisulfite was prepared using processes and equipment normally used in cast film production by adding the Masterbatch containing a 40% sodium metabisulfite loading to the polymer extruder and extruding a 3000 cm² film weighing about 9.18 grams and having a thickness of about 150 μm to about 180 μm. The film contained about 3.67 grams of sodium metabisulfite.

The films were evaluated for sulfur dioxide release under accelerated testing at 20° C. and 95% relative humidity with actual evaluation times reported in hours and the corresponding number of days based on the accelerating testing procedure also reported. The results are reported in Table 1.

TABLE 1

| | | ppm SO₂ | ppm SO₂ | ppm SO₂ |
|---|---|---|---|---|
| Time (hr) | Time (days) | 16% Na₂MB | 20% Na₂MB | 37% Na₂MB |
| 0 | 0 | 0 | 0 | 0 |
| 1 | 0.8 | 5.5 | 23 | 19.0 |
| 2 | 1.5 | 2.5 | 27.5 | 24.0 |
| 3 | 2.3 | 2.0 | 23.5 | 18.0 |
| 4 | 3.0 | 4.0 | 28.5 | 28.0 |
| 5 | 3.8 | 5.0 | 27.0 | 29.0 |
| 6 | 4.5 | 4.5 | 25.5 | 27.5 |
| 7 | 5.3 | 4.0 | 26.5 | 27.5 |
| 22 | 16.5 | 20.5 | 112.5 | 186.5 |
| 23 | 17.3 | 27.0 | 126.0 | 133.5 |
| 24 | 18.0 | 21.5 | 92.5 | 144.0 |
| 25 | 18.8 | 24.0 | 91.0 | 137.5 |
| 26 | 19.5 | 23.0 | 93.5 | 135.5 |
| 27 | 20.3 | 22.5 | 91.5 | 135.0 |
| 28 | 21.0 | 21.5 | 91.5 | 130.0 |
| 29 | 21.8 | 20.5 | 92.0 | 133.0 |
| 44 | 33.0 | 44.5 | 67.5 | 140.5 |
| 45 | 33.8 | 43.0 | 40.5 | 82.0 |
| 46 | 34.5 | 31.5 | 35.0 | 72.5 |
| 47 | 35.3 | 29.0 | 36.0 | 74.5 |
| 48 | 36.0 | 30.0 | 30.5 | 78.5 |
| 49 | 36.8 | 29.0 | 26.5 | 77.0 |
| 50 | 37.5 | 29.5 | 27.5 | 72.0 |
| 65 | 48.8 | 46.5 | 5.5 | 24.0 |
| 66 | 49.5 | 46.5 | 5.0 | 21.5 |
| 67 | 50.3 | 46.5 | 4.0 | 21.5 |
| 68 | 51.0 | 46.5 | 4.0 | 21.5 |
| 69 | 51.8 | 46.5 | 4.0 | 21.5 |
| 70 | 52.5 | 46.0 | 5.0 | 22.0 |
| 71 | 53.3 | 47.0 | 4.0 | 21.5 |
| 72 | 54.0 | 43.5 | 4.5 | 21.5 |
| 87 | 65.3 | 16.0 | 1.0 | 7.5 |
| 88 | 66.0 | 16.0 | 0.5 | 4.5 |
| 89 | 66.8 | 14.5 | 0.5 | 4.0 |
| 90 | 67.5 | 14.0 | 0 | 3.5 |
| 91 | 68.3 | 16.0 | 0 | 1.5 |
| 92 | 69.0 | 15.5 | — | — |
| 93 | 69.8 | 14.5 | — | — |
| 94 | 70.5 | 14.0 | — | — |
| 159 | 119.3 | 3.5 | — | — |
| 160 | 120.0 | 2.5 | — | — |
| 161 | 120.8 | 2.5 | — | — |
| 162 | 121.5 | 1.5 | — | — |
| 163 | 122.3 | 2.0 | — | — |
| 164 | 123.0 | 1.0 | — | — |

The 20% and 37% sodium metabisulfite loaded film sulfur dioxide emissions reached 20-30 ppm during the first hours without showing a fast phase emission. An increase in emissions occurred during the second day of evaluation reaching 70-110 ppm and 140 ppm for the 20% and 40% loaded films, respectively. The total accelerated testing emission time for the films was about 75 hours. That time corresponds to about 45-68 days under standard commercial table grape storage and transport conditions.

The 16% sodium metabisulfite loaded film had a lower emission rate that was very constant over time. Sulfur dioxide was released over the equivalent of a 60-90 day duration period under standard commercial table grape storage conditions.

This method of this example involved a container that was not tightly sealed such that some sulfur dioxide emissions to the exterior of the bag occurred. By sealing the box, the gas releasing polymer article would only emit to the interior of the box and thereby secure emissions longer than 45-60 days. An emission period of up to 120 days is achievable.

### Example 3

A monolayer film containing 12% by weight of sodium metabisulfite was prepared by adding (1) Masterbatch containing a 40% sodium metabisulfite loading and (2) LDPE to the polymer extruder at a Masterbatch to LDPE weight percent ratio of 3:7. An extruded film having: a thickness of about 25 μm to about 75 μm was prepared.

A laminated film was also produced. Lamination was made to a plain monolayer film not containing any NaMSB and having a thickness of about 20 μm to about 50 μm using thermal pressure without an adhesive layer comprised of the same polyolefinic resin as the test film material.

The films were evaluated for sulfur dioxide release under accelerated testing at 20° C. and 95% relative humidity with actual evaluation times reported in hours and the corresponding number of days based on the accelerating testing procedure also reported. The results are reported in Table 2.

TABLE 2

| Time (hr) | Time (days) | ppm SO₂ - Laminated | ppm SO₂ - monolayer |
|---|---|---|---|
| 0 | 0 | 0 | 0 |
| 1 | 0.8 | 13.7 | 29.7 |
| 2 | 1.5 | 10.7 | 21.3 |
| 3 | 2.3 | 16.7 | 17.3 |
| 4 | 3.0 | 15.3 | 17.0 |
| 5 | 3.8 | 16.0 | 21.0 |
| 20 | 15.0 | 84.3 | 88.3 |
| 21 | 15.8 | 86.3 | 89.7 |
| 22 | 16.5 | 85.7 | 87.0 |
| 23 | 17.3 | 86.0 | 84.3 |
| 24 | 18.0 | 92.3 | 72.7 |
| 25 | 18.8 | 91.3 | 72.0 |
| 26 | 19.5 | 91.0 | 73.0 |
| 27 | 20.3 | 96.0 | 56.3 |
| 42 | 31.5 | 43.7 | 15.0 |
| 43 | 32.3 | 37.3 | 13.7 |
| 44 | 33.0 | 37.7 | 15.0 |
| 45 | 33.8 | 38.0 | 14.0 |
| 46 | 34.5 | 38.3 | 15.0 |
| 47 | 35.3 | 37.0 | 15.7 |
| 48 | 36.0 | 37.0 | 11.7 |
| 49 | 36.8 | 29.0 | 6.7 |
| 64 | 48.0 | 22.7 | 3.3 |
| 65 | 48.8 | 22.3 | 3.3 |
| 66 | 49.5 | 21.7 | 2.3 |
| 67 | 50.3 | 19.3 | 1.7 |
| 68 | 51.0 | 15.3 | 1.0 |
| 69 | 51.8 | 15.7 | 1.0 |
| 70 | 52.5 | 14.7 | 1.0 |
| 71 | 53.3 | 13.7 | 1.0 |
| 86 | 64.5 | 5.0 | — |
| 87 | 65.3 | 4.7 | — |
| 88 | 66.0 | 4.0 | — |
| 89 | 66.8 | 3.0 | — |
| 90 | 67.5 | 3.3 | — |
| 91 | 68.3 | 2.3 | — |
| 92 | 69.0 | 1.7 | — |
| 93 | 69.8 | 1.0 | — |

### Example 4

A monolayer film containing 16% by weight of sodium metabisulfite was prepared by adding (1) Masterbatch containing a 40% sodium metabisulfite loading and (2) LDPE to the polymer extruder at a Masterbatch to LDPE weight percent ratio of 3:7. An extruded film having: a thickness of about 25 μm to about 75 μm was prepared.

The films were evaluated for sulfur dioxide release under accelerated testing at 20° C. and 95% relative humidity with actual evaluation times reported in hours and the corresponding number of days based on the accelerating testing procedure also reported. The results are reported in Table 3.

TABLE 3

| Time (hr) | Time (days) | ppm SO₂ 16% Na₂MB |
|---|---|---|
| 0 | 0 | 0 |
| 1 | 0.8 | 2.7 |
| 2 | 1.5 | 1.7 |
| 3 | 2.3 | 1.3 |
| 4 | 3.0 | 1.7 |
| 5 | 3.8 | 0.7 |
| 6 | 4.5 | 1.3 |
| 7 | 5.3 | 2.0 |
| 22 | 16.5 | 42.7 |
| 23 | 17.3 | 41.3 |
| 24 | 18.0 | 38.0 |
| 25 | 18.8 | 38.3 |
| 26 | 19.5 | 39.7 |
| 27 | 20.3 | 38.7 |
| 28 | 21.0 | 36.7 |
| 29 | 21.8 | 33.7 |
| 44 | 33.0 | 71.0 |
| 45 | 33.8 | 64.7 |
| 46 | 34.5 | 65.0 |
| 47 | 35.3 | 61.7 |
| 48 | 36.0 | 59.3 |
| 49 | 36.8 | 55.0 |
| 50 | 37.5 | 57.3 |
| 51 | 38.3 | 43.3 |
| 66 | 49.5 | 13.0 |
| 67 | 50.3 | 11.7 |
| 68 | 51.0 | 8.7 |
| 69 | 51.8 | 9.3 |
| 70 | 52.5 | 9.7 |
| 71 | 53.3 | 12.0 |
| 72 | 54.0 | 9.7 |
| 87 | 65.3 | 11.7 |
| 88 | 66.0 | 10.0 |
| 89 | 66.8 | 8.0 |
| 90 | 67.5 | 3.3 |
| 91 | 68.3 | 3.3 |
| 92 | 69.0 | 3.0 |
| 93 | 69.8 | 3.3 |

### Example 5

A monolayer film containing 20% by weight of sodium metabisulfite was prepared by adding (1) Masterbatch containing a 40% sodium metabisulfite loading and (2) LDPE to the polymer extruder at a Masterbatch to LDPE weight percent ratio of 1:1. An extruded film having a thickness of about 50 μm to about 100 μm was prepared.

The film was evaluated in duplicate for sulfur dioxide release at commercial storage conditions of at 4° C. and 95% relative humidity. The results are reported in Table 4.

TABLE 4

| Time (hr) | Sheet 1 | Sheet 2 | Average |
|---|---|---|---|
| 0 | 0 | 0 | 0 |
| 2 | 0 | 0 | 0 |
| 4 | 0 | 0 | 0 |
| 6 | 0 | 0 | 0 |
| 22 | 1 | 8 | 5 |
| 24 | 1 | 7 | 4 |
| 26 | 1 | 7 | 4 |
| 28 | 2 | 2 | 2 |
| 44 | 3 | 11 | 7 |
| 46 | 4 | 10 | 7 |
| 48 | 4 | 10 | 7 |
| 50 | 5 | 11 | 8 |
| 116 | 10 | 21 | 16 |
| 118 | 15 | 22 | 19 |
| 120 | 16 | 25 | 21 |
| 122 | 17 | 22 | 20 |
| 124 | 18 | 21 | 20 |
| 140 | 4 | 11 | 8 |
| 142 | 5 | 12 | 9 |
| 144 | 6 | 15 | 11 |
| 146 | 5 | 21 | 13 |
| 162 | 3 | 15 | 9 |
| 164 | 2 | 13 | 8 |
| 166 | 3 | 11 | 7 |
| 168 | 2 | 12 | 7 |
| 172 | 3 | 9 | 6 |
| 182 | 4 | 10 | 7 |
| 184 | 3 | 9 | 6 |
| 186 | 2 | 5 | 4 |
| 188 | 3 | 4 | 4 |
| 254 | 5 | 10 | 8 |
| 256 | 6 | 11 | 9 |
| 258 | 7 | 12 | 10 |
| 260 | 6 | 13 | 10 |
| 276 | 6 | 12 | 9 |
| 282 | 6 | 12 | 9 |
| 298 | 7 | 15 | 11 |
| 300 | 7 | 13 | 10 |
| 302 | 6 | 12 | 9 |
| 304 | 5 | 11 | 8 |
| 320 | 1 | 0 | 1 |
| 322 | 0 | 0 | 0 |
| 324 | 0 | 0 | 0 |

1. A sulfur dioxide gas generating and gas releasing monolayer article consisting essentially of between 30.0% and 99.9% by weight of a polymer and between 0.1% and 70.0% by weight of a gas generating solid dispersed in the polymer, wherein the article is free of an acid, a polymer that degrades to produce an acid, a compound that generates an acid in response to humidity, a hygroscopic compound, and an oxidant, the gas generating solid being capable of generating and releasing sulfur dioxide gas upon exposure of the article to moisture.

2. The article of claim 1 wherein the gas generating solid is capable of generating and releasing a second gas selected from at least one of chlorine dioxide, carbon dioxide, ozone, nitrous oxide, chlorine and hydrogen peroxide.

3. The article of claim 2 wherein the gas generating solid is capable of generating and releasing a mixture of sulfur dioxide and chlorine dioxide.

4. The article of claim 1 wherein the gas generating and releasing solid is between 10.0% and 60.0% by weight.

5. The article of claim 1 wherein the gas generating solid consists essentially of a sulfur dioxide gas generating and releasing salt and at least one component selected from an energy-activated gas generating and releasing component, an organic moisture-activated gas generating and releasing component and an inorganic moisture-activated gas generating and releasing component.

6. The article of claim 1 wherein the gas generating solid consists essentially of a sulfur dioxide gas generating and releasing salt.

7. The article of claim 6 wherein the sulfur dioxide gas generating and releasing salt is selected from sodium bisulfite, potassium bisulfite, lithium bisulfite, calcium bisulfite, sodium metabisulfite, potassium metabisulfite, lithium metabisulfite, calcium metabisulfite, sodium sulfite and potassium sulfite.

8. The article of claim 7 wherein the sulfur dioxide gas generating and releasing salt is selected from sodium metabisulfite, potassium metabisulfite, lithium metabisulfite and calcium metabisulfite.

9. The article of claim 1 wherein the polymer is selected from polyolefins, polyvinyl chloride, nitrile, nylon, polyethylene terephthalate, polyurethane, polytetrafluoroethylene, silicone rubber, neoprene and polyvinyidiene chloride.

10. The article of claim 9 wherein the polymer is formed from a resin having a melt index between about 0.5 and about 8.0.

11. The article of claim 9 wherein the polymer is formed from a resin having a melt temperature between about 105° C. and about 150° C.

12. The article of claim 9 wherein the polymer is a polyolefin selected from one or more of polyethylene, butene base, heptene base, octene base and metalacene polyethylene.

13. The article of claim 1 wherein the article is selected from a sheet, bag, envelope, pad, foam, insert, tray, cover, liner, carton, box, crate, pallet and bin.

14. A bi-layer gas generating and releasing article formed from the article of claim 1 and a second article wherein a first surface of the article of claim 1 is conjoined with a surface of the second article.

15. The bi-layer article of claim 14 wherein the second article releases a gas upon exposure to moisture or energy.

16. The bi-layer article of claim 14 wherein the second article does not release a gas.

17. The bi-layer article of claim 14 wherein the second article is selected from a sheet, bag, envelope, pad, foam, insert, tray, cover, liner, carton, box, crate, pallet and bin.

18. A multi-layer gas generating and releasing article formed from the article of claim 1, a second article and a third article wherein a first surface of the article of claim 1 is conjoined with a surface of the second article and a second surface of the article of claim 1 is conjoined with a surface of the third article.

19. The multi-layer article of claim 18 wherein the second article and the third article do not release a gas.

20. The multi-layer article of claim 18 wherein the second article releases a gas upon exposure to moisture or energy and the third article does release a gas.

21. The multi-layer article of claim 18 wherein the second article and the third article independently release a gas upon exposure to moisture or energy.

22. The multi-layer article of claim 18 wherein the second article and the third article are independently selected from a sheet, bag, envelope, pad, foam, insert, tray, cover, liner, carton, box, crate, pallet and bin.

23. A gas generating and gas releasing monolayer article comprising between 30.0% and 99.9% by weight of a first polymer and between 0.1% and 70.0% by weight of a gas generating solid dispersed in the polymer, wherein the article is free of an acid, a second polymer, a compound that generates an acid in response to humidity, a hygroscopic compound, and an oxidant, the gas generating solid consisting essentially of one or more gas generating and releasing components with at least one component being capable of generating and releasing at least one gas upon exposure of the article to moisture.

24. The article of claim 23 wherein the gas is selected from at least one of sulfur dioxide, chlorine dioxide, carbon dioxide, ozone, nitrous oxide, chlorine and hydrogen peroxide.

25. The article of claim 24 wherein the gas is a mixture of sulfur dioxide and chlorine dioxide.

26. The article of claim 25 wherein the gas is sulfur dioxide.

27. The article of claim 23 wherein the gas generating and releasing solid is between 10.0% and 60.0% by weight.

28. The article of claim 23 wherein the gas generating solid consists essentially of a sulfur dioxide gas generating and releasing salt component and at least one component selected from an energy-activated gas generating and releasing component, an organic gas generating and releasing component and an inorganic gas generating and releasing component.

29. The article of claim 23 wherein the gas generating solid consists essentially of a sulfur dioxide gas generating and releasing salt component.

30. The article of claim 29 wherein the sulfur dioxide gas generating and releasing salt component is selected from sodium bisulfite, potassium bisulfite, lithium bisulfite, calcium bisulfite, sodium metabisulfite, potassium metabisulfite, lithium metabisulfite, calcium metabisulfite, sodium sulfite and potassium sulfite.

31. The article of claim 30 wherein the sulfur dioxide gas generating and releasing salt component is selected from sodium metabisulfite, potassium metabisulfite, lithium metabisulfite and calcium metabisulfite.

32. The article of claim 23 wherein the first polymer is selected from polyolefins, polyvinyl chloride, nitrile, nylon, polyethylene terephthalate, polyurethane, polytetrafluoroethylene, silicone rubber, neoprene and polyvinyldiene chloride.

33. The article of claim 32 wherein the first polymer is formed from a resin having a melt index between about 0.5 and about 8.0.

34. The article of claim 32 wherein the first polymer is formed from a resin having a melt temperature between about 105° C. and about 150° C.

35. The article of claim 32 wherein the first polymer is a polyolefin selected from one or more of polyethylene, butene base, heptene base, octene base and metalacene polyethylene.

36. The article of claim 23 wherein the article is selected from a sheet, bag, envelope, pad, foam, insert, tray, cover, liner, carton, box, crate, pallet and bin.

37. A bi-layer gas generating and releasing article formed from the article of claim 23 and a second article wherein a first surface of the article of claim 23 is conjoined with a surface of the second article.

38. The bi-layer article of claim 37 wherein the second article releases a gas upon exposure to moisture or energy.

39. The bi-layer article of claim 37 wherein the second article does not release a gas.

40. The bi-layer article of claim 37 wherein the second article is selected from a sheet, bag, envelope, pad, foam, insert, tray, cover, liner, carton, box, crate, pallet and bin.

41. A multi-layer gas generating and releasing article formed from the article of claim 23, a second article and a third article wherein a first surface of the article of claim 23 is conjoined with a surface of the second article and a second surface of the article of claim 23 is conjoined with a surface of the third article.

42. The multi-layer article of claim 41 wherein the second article and the third article do not release a gas.

43. The multi-layer article of claim 41 wherein the second article releases a gas upon exposure to moisture or energy and the third article does release a gas.

44. The multi-layer article of claim 41 wherein the second article and the third article independently release a gas upon exposure to moisture or energy.

45. The multi-layer article of claim 41 wherein the second article and the third article are independently selected from a sheet, bag, envelope, pad, foam, insert, tray, cover, liner, carton, box, crate, pallet and bin.

46. A gas generating and gas releasing article comprising between 30.0% and 99.9% by weight of a first polymer and between 0.1% and 70.0% by weight of a gas generating solid dispersed in the polymer, wherein the article is free of an acid, a second polymer, a compound that generates an acid in response to humidity, a hygroscopic compound, and an oxidant, the gas generating solid consisting essentially of one or more gas generating and releasing components with at least one component being capable of generating and releasing at least one gas upon exposure of the article to moisture.

47. The article of claim 46 wherein the gas is selected from at least one of sulfur dioxide, chlorine dioxide, carbon dioxide, ozone, nitrous oxide, chlorine and hydrogen peroxide.

48. The article of claim 47 wherein the gas is a mixture of sulfur dioxide and chlorine dioxide.

49. The article of claim 48 wherein the gas is sulfur dioxide.

50. The article of claim 46 wherein the gas generating and releasing solid is between 10.0% and 60.0% by weight.

51. The article of claim 46 wherein the gas generating solid consists essentially of a sulfur dioxide gas generating and releasing salt component and at least one component selected from an energy-activated gas generating and releasing component, an organic gas generating and releasing component and an inorganic gas generating and releasing component.

52. The article of claim 46 wherein the gas generating solid consists essentially of a sulfur dioxide gas generating and releasing salt component.

53. The article of claim 52 wherein the sulfur dioxide gas generating and releasing salt component is selected from sodium bisulfite, potassium bisulfite, lithium bisulfite, calcium bisulfite, sodium metabisulfite, potassium metabisulfite, lithium metabisulfite, calcium metabisulfite, sodium sulfite and potassium sulfite.

54. The article of claim 53 wherein the sulfur dioxide gas generating and releasing salt component is selected from sodium metabisulfite, potassium metabisulfite, lithium metabisulfite and calcium metabisulfite.

55. The article of claim 46 wherein the first polymer is selected from polyolefins, polyvinyl chloride, nitrile, nylon, polyethylene terephthalate, polyurethane, polytetrafluoroethylene, silicone rubber, neoprene and polyvinyldiene chloride.

56. The article of claim 55 wherein the first polymer is formed from a resin having a melt index between about 0.5 and about 8.0.

57. The article of claim 55 wherein the first polymer is formed from a resin having a melt temperature between about 105° C. and about 150° C.

58. The article of claim 55 wherein the first polymer is a polyolefin selected from one or more of polyethylene, butene base, heptene base, octene base and metalacene polyethylene.

59. The article of claim 46 wherein the article is selected from a sheet, bag, envelope, pad, foam, insert, tray, cover, liner, carton, box, crate, pallet and bin.

60. A bi-layer gas generating and releasing article formed from the article of claim 46 and a second article wherein a first surface of the article of claim 46 is conjoined with a surface of the second article.

61. The bi-layer article of claim 60 wherein the second article releases a gas upon exposure to moisture or energy.

62. The bi-layer article of claim 60 wherein the second article does not release a gas.

63. The bi-layer article of claim 60 wherein the second article is selected from a sheet, bag, envelope, pad, foam, insert, tray, cover, liner, carton, box, crate, pallet and bin.

64. A multi-layer gas generating and releasing article formed from the article of claim 46, a second article and a third article wherein a first surface of the article of claim 46 is conjoined with a surface of the second article and a second surface of the article of claim 46 is conjoined with a surface of the third article.

65. The multi-layer article of claim 64 wherein the second article and the third article do not release a gas.

66. The multi-layer article of claim 64 wherein the second article releases a gas upon exposure to moisture or energy and the third article does release a gas.

67. The multi-layer article of claim 64 wherein the second article and the third article independently release a gas upon exposure to moisture or energy.

68. The multi-layer article of claim 64 wherein the second article and the third article are independently selected from a sheet, bag, envelope, pad, foam, insert, tray, cover, liner, carton, box, crate, pallet and bin.
